(19) United States
(12) Patent Application Publication
(10) Pub. No.: US 2026/0351913 A1
(43) Pub. Date: Nov. 5, 2026

(54) BACKPACK POWER ADAPTER

(71) Applicant: SHANGHAI ELECTRIC TOOLS RESEARCH INSTITUTE (GROUP) CO., LTD., Shanghai (CN)

(72) Inventors: Dian WANG, Shanghai (CN); Qiyao BO, Shanghai (CN); Wenchao XI, Shanghai (CN); Zhiguo SHEN, Shanghai (CN); Xu ZHU, Shanghai (CN)

(73) Assignee: SHANGHAI ELECTRIC TOOLS RESEARCH INSTITUTE (GROUP) CO., LTD., Shanghai (CN)

(21) Appl. No.: 19/709,069

(22) Filed: Jun. 16, 2026

Related U.S. Application Data
(63) Continuation of application No. PCT/CN2025/095346, filed on May 16, 2025.

(30) Foreign Application Priority Data
Nov. 13, 2024 (CN) 202411618456.4

(51) Int. Cl. H01R 31/06; H01R 13/02; H01R 13/512; H01R 13/58; H01R 13/627; H01R 13/66

(52) U.S. Cl. CPC H01R 31/065; H01R 13/025; H01R 13/512; H01R 13/5816; H01R 13/5841; H01R 13/6272; H01R 13/6658

(57) ABSTRACT

A backpack power adapter includes a device body, where the device body is provided with a circuit board and a cable configured to supply power to a power tool, where a movable rotating body is provided in the device body, and the rotating body is provided with a cable passage; one end of the cable passes through the cable passage and is electrically connected to the circuit board, and the other end of the cable extends out of the device body; and the device body is provided with receiving slots in multiple directions for receiving and clamping the cable. The receiving slots in multiple directions are provided for receiving the cable. The rotating body allows the cable to be selectively rotated into a receiving slot in any of the multiple directions, thereby greatly expanding the application range and improving the user convenience.

### CROSS REFERENCE TO THE RELATED APPLICATIONS

This application is a continuation application of International Application No. PCT/CN 2025/095346, filed on May 16, 2025, which is based upon and claims priority to Chinese Patent Application No. 202411618456.4, filed on Nov. 13, 2024, the entire contents of which are incorporated herein by reference.

### TECHNICAL FIELD

The present invention relates to the technical field of power supply, and particularly to a backpack power adapter.

### BACKGROUND

Backpack power supplies offer advantages such as portability, extended power supply duration, and multifunctionality, making them widely applicable in fields such as emergency rescue, field operations, and outdoor exploration. Currently, most adapters which are specific for backpack power supplies on the market can only fix the output cables in two directions for use with specific power tools, thereby limiting the range of applicable power tools, lacking versatility, and causing inconvenience to users.

### SUMMARY

To address the problems existing in the prior art, at least one embodiment of the present invention provides a backpack power adapter, which greatly expands the application range and improves the user convenience.

An embodiment of the present invention provides a backpack power adapter, including a device body, where the device body is provided with a circuit board and a cable configured to supply power to a power tool; a movable rotating body is provided in the device body, and the rotating body is provided with a cable passage; one end of the cable passes through the cable passage and is electrically connected to the circuit board, and the other end of the cable extends out of the device body; and the device body is provided with receiving slots in multiple directions for receiving and clamping the cable.

In some embodiments, in the backpack power adapter provided by the present invention, the rotating body includes a first hemispherical shell, a second hemispherical shell, and an arc-shaped slide plate, where the first hemispherical shell is connected to the second hemispherical shell; both the first hemispherical shell and the second hemispherical shell are provided with arc-shaped grooves corresponding to the arc-shaped slide plate, and the arc-shaped slide plate is slidably connected in the arc-shaped grooves; both the first hemispherical shell and the second hemispherical shell are provided with cable clamping grooves and first through holes communicating with the cable clamping grooves, and the arc-shaped slide plate is provided with a second through hole.

In some embodiments, in the backpack power adapter provided by the present invention, walls of the arc-shaped grooves are provided with slide grooves, both sides of the arc-shaped slide plate are provided with slide protrusions corresponding to the slide grooves, and the slide protrusions are engaged with the slide grooves.

In some embodiments, in the backpack power adapter provided by the present invention, the device body includes an upper shell and a lower shell, and the upper shell is connected to the lower shell; and the lower shell is provided with a hollowed-out body, where a plurality of rotation support blocks are provided in the hollowed-out body, and rotation support surfaces of the rotation support blocks are adapted to the first hemispherical shell and the second hemispherical shell.

In some embodiments, in the backpack power adapter provided by the present invention, pressing plate and a first mounting column are provided in the lower shell, and the pressing plate is mounted in the lower shell via the first mounting column; and the pressing plate is provided with a hollowed-out portion corresponding to the hollowed-out body, the hollowed-out portion has a four-leaf clover-shaped structure, and a plurality of limiting stop plates are provided around the hollowed-out portion.

In some embodiments, in the backpack power adapter provided by the present invention, t he pressing plate is provided with a first boss corresponding to the first mounting column, and a bottom of the first boss is provided with a positioning groove adapted to the first mounting column; and the first mounting column is provided with a first screw hole, and the first boss is provided with a second screw hole corresponding to the first screw hole.

In some embodiments, in the backpack power adapter provided by the present invention, the receiving slots are located at the bottom of the lower shell in four directions, with every two of the receiving slots being perpendicular to each other.

In some embodiments, in the backpack power adapter provided by the present invention, the bottom of the lower shell is provided with a disassembly groove.

In some embodiments, in the backpack power adapter provided by the present invention, a plurality of second mounting columns are provided in the lower shell, and the circuit board is mounted in the lower shell via the second mounting columns, where at least two of the second mounting columns are provided with second bosses.

In some embodiments, in the backpack power adapter provided by the present invention, the device body is provided with a spring and a buckle configured to be mounted and positioned with the power tool, one end of the buckle is provided with a movement block, and the lower shell is connected to a movement groove corresponding to the movement block; the other end of the buckle is provided with a protruding block, the lower shell is provided with a positioning column, one end of the spring is connected to the protruding block, and the other end of the spring is connected to the positioning column.

Therefore, the embodiments of the present invention provide a backpack power adapter, which is provided with receiving slots in multiple directions for receiving the cable. The rotating body allows the cable to be selectively rotated into a receiving slot in any of the multiple directions, thereby greatly expanding the application range and improving the user convenience.

### BRIEF DESCRIPTION OF THE DRAWINGS

To more clearly illustrate the technical solutions of the embodiments of the present invention, the drawings required for describing the embodiments or the prior art will be briefly introduced below. Apparently, the drawings described below are merely some embodiments of the present invention. For those having ordinary skill in the art, other drawings can be obtained based on these drawings without involving any inventive effort.

FIG. 1 shows a schematic view showing the structure of a backpack power adapter according to an embodiment of the present invention;

FIG. 2 shows a schematic view showing the frame of the backpack power adapter according to an embodiment of the present invention;

FIG. 3 shows a schematic view showing the structure of a pressing plate according to an embodiment of the present invention;

FIG. 4 shows a schematic view showing the structure of a lower shell according to an embodiment of the present invention;

FIG. 5 shows a schematic view showing the structure of a rotating body according to an embodiment of the present invention;

FIG. 6 shows a schematic view showing the structure of an arc-shaped slide plate according to an embodiment of the present invention;

FIG. 7 shows a schematic view showing the structure of a first hemispherical shell and a second hemispherical shell according to an embodiment of the present invention;

FIG. 8 shows a schematic view of a cable direction being forward according to an embodiment of the present invention;

FIG. 9 shows a schematic view of a cable direction being backward according to an embodiment of the present invention;

FIG. 10 shows a schematic view of a cable direction being leftward according to an embodiment of the present invention;

FIG. 11 shows a schematic view of a cable direction being rightward according to an embodiment of the present invention;

FIG. 12 shows a schematic view of a backpack power adapter mounted on an electric wrench according to an embodiment of the present invention;

FIG. 13 shows a schematic view of a backpack power adapter mounted on a cutting machine according to an embodiment of the present invention; and

FIG. 14 shows a schematic view of a backpack power adapter mounted on an electric hammer according to an embodiment of the present invention.

The reference numerals in the drawings corresponding to the specification are as follows:

circuit board 1, cable 2, power connector 21, rotating body 3, first hemispherical shell 31, second hemispherical shell 32, arc-shaped slide plate 33, second through hole 331, slide protrusion 332, arc-shaped groove 34, cable clamping groove 35, first through hole 351, first self-tapping screw 36, third screw hole 37, receiving slot 4, upper shell 5, lower shell 6, hollowed-out body 61, rotation support block 611, disassembly groove 62, second mounting column 63, second boss 631, movement groove 64, positioning column 65, pressing plate 7, first mounting column 71, first screw hole 711, hollowed-out portion 72, limiting stop plate 73, first boss 74, positioning groove 741, second screw hole 742, second self-tapping screw 75, spring 8, buckle 9, movement block 91, and protruding block 92.

### DETAILED DESCRIPTION OF THE EMBODIMENTS

To make the objectives, technical solutions, and advantages of the embodiments of the present invention clearer, the technical solutions of the embodiments of the present invention will be clearly and completely described below with reference to the drawings of the embodiments of the present invention. Apparently, the described embodiments are only some, rather than all, of the embodiments of the present invention. All other embodiments obtained by those having ordinary skill in the art based on the embodiments of the present invention without involving any inventive effort shall fall within the scope of protection of the present invention.

It should be noted that, in this document, relational terms such as “first” and “second” are used merely to distinguish one entity or operation from another entity or operation, and do not necessarily require or imply any such actual relationship or order between these entities or operations. In this document, the terms “comprising,” “including,” or any other variations thereof are intended to cover non-exclusive inclusion, such that a process, method, article, or apparatus that includes a list of elements includes not only those elements, but also other elements not expressly listed, or elements inherent to such a process, method, article, or apparatus. Without further limitation, an element defined by the phrase “including a/an . . . ” does not preclude the presence of additional identical elements in the process, method, article, or apparatus that includes that element.

It is found that, in the prior art, most adapters which are specific for backpack power supplies on the market can only fix the output cables in two directions for use with specific power tools, thereby limiting the range of applicable power tools, lacking versatility, and causing inconvenience to users. The embodiments of the present invention provide the following solution:

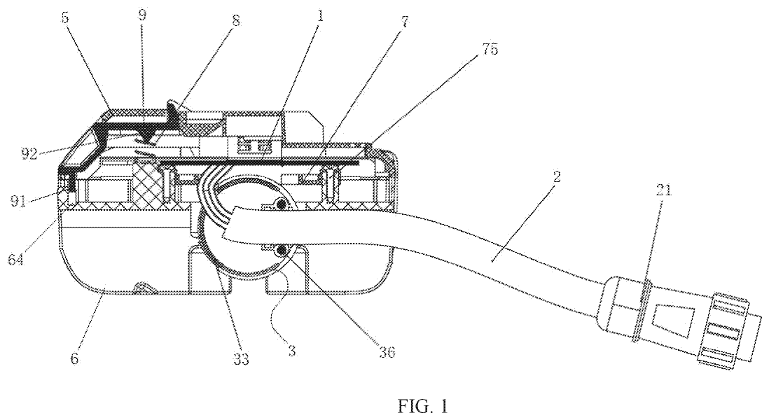

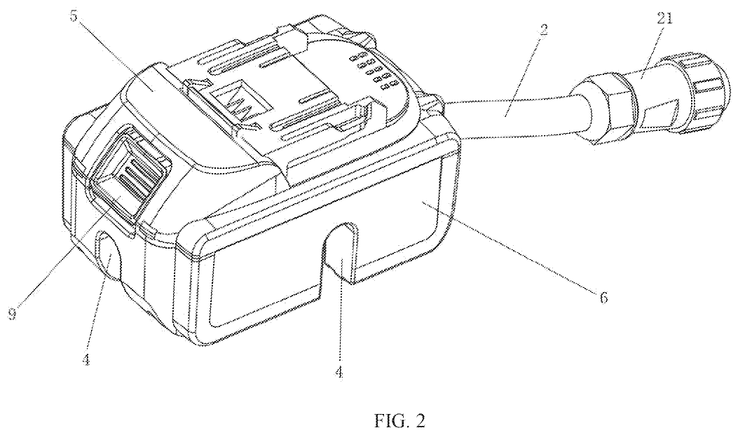

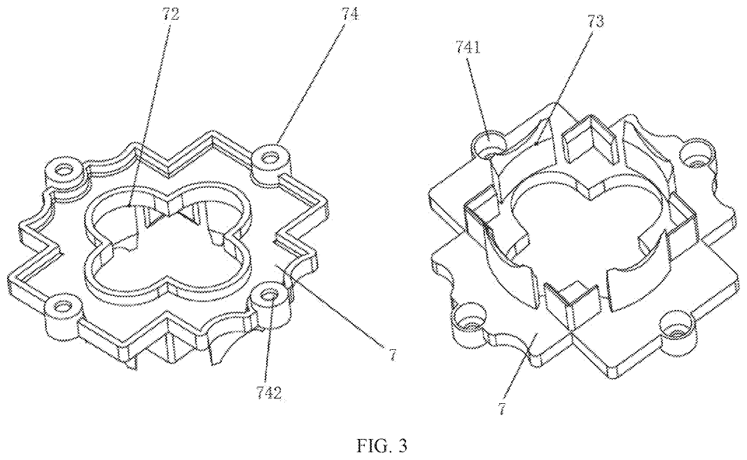

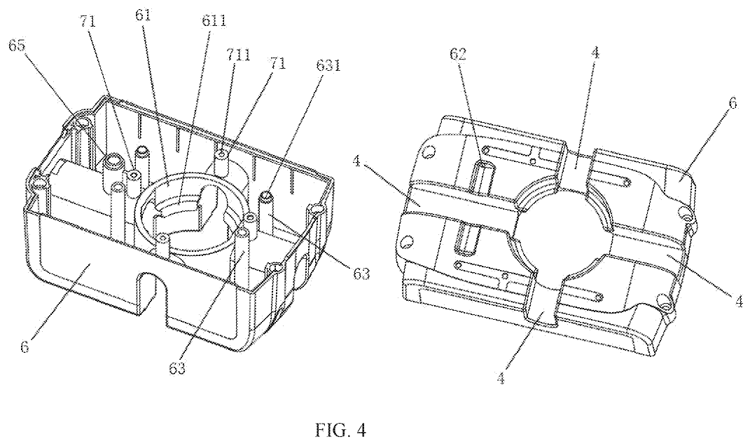

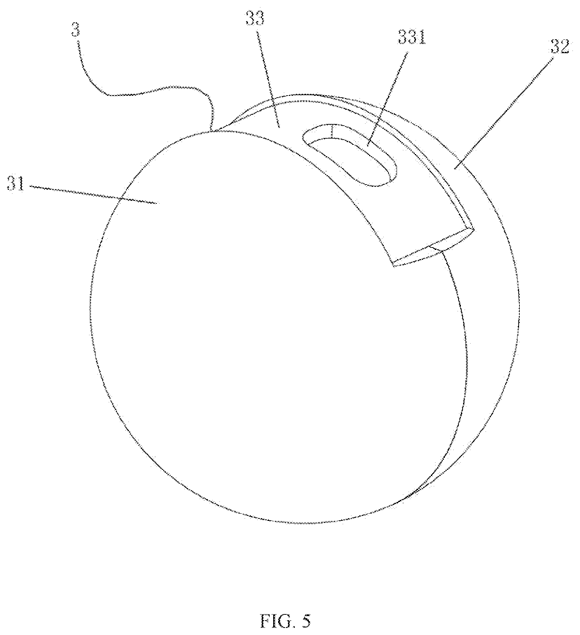

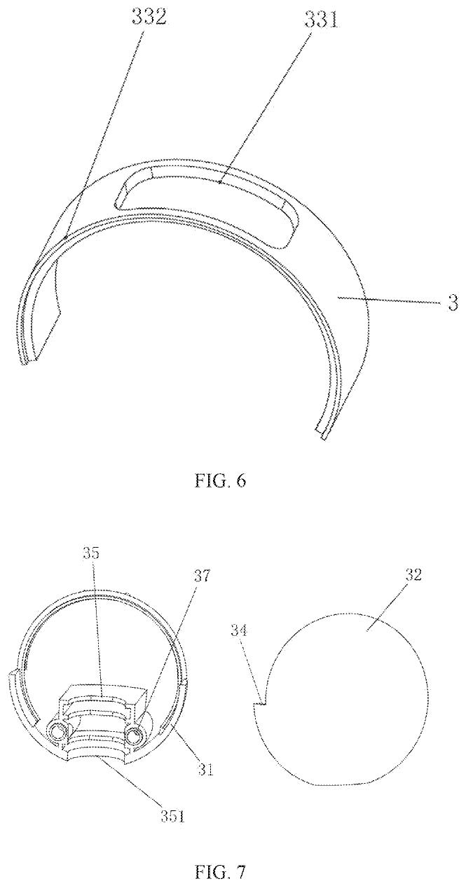

As shown in FIGS. 1-7, an embodiment of the present invention provides a backpack power adapter, including a device body. The device body is provided with a circuit board 1 and a cable 2 configured to supply power to a power tool. A movable rotating body 3 is provided in the device body, and the rotating body 3 is provided with a cable passage. One end of the cable 2 passes through the cable passage and is electrically connected to the circuit board 1, and the other end of the cable 2 extends out of the device body. The device body is provided with receiving slots 4 in multiple directions for receiving and clamping the cable.

It should be noted that the cable 2 is rotated to face different directions in the device body by the rotating body 3, so that receiving slots 4 in different directions can be selected for placement and clamping according to the usage requirements of different power tools. The receiving slot 4 achieves an interference fit with the cable 2, so that the cable 2 is placed and clamped in the receiving slot 4. After clamping, the power connector 21 of the cable 2 is inserted into the power connector on the power tool.

In some embodiments, the rotating body 3 includes a first hemispherical shell 31, a second hemispherical shell 32, and an arc-shaped slide plate 33. The first hemispherical shell 31 is connected to the second hemispherical shell 32. Both the first hemispherical shell 31 and the second hemispherical shell 32 are provided with arc-shaped grooves 34 corresponding to the arc-shaped slide plate 33, and the arc-shaped slide plate 33 is slidably connected in the arc-shaped grooves 34. Both the first hemispherical shell 31 and the second hemispherical shell 32 are provided with cable clamping grooves 35 and first through holes 351 communicating with the cable clamping grooves 35. The arc-shaped slide plate 33 is provided with a second through hole 331. The device body includes an upper shell 5 and a lower shell 6, and the upper shell 5 is connected to the lower shell 6. The lower shell 6 is provided with a hollowed-out body 61, and a plurality of rotation support blocks 611 are provided in the hollowed-out body 61. Rotation support surfaces of the rotation support blocks 611 are adapted to the first hemispherical shell 31 and the second hemispherical shell 32.

It should be noted that the upper shell 5 and the lower shell 6 are fixedly connected by four screws. The first hemispherical shell 31 is provided with a third screw hole 37. After a first self-tapping screw 36 is screwed into the third screw hole 37, the first hemispherical shell 31 is fixedly connected to the second hemispherical shell 32. After connection, the cable clamping grooves 35 of the first hemispherical shell 31 and the second hemispherical shell 32 combine to form a cable clamping channel, and the first through holes 351 of the first hemispherical shell 31 and the second hemispherical shell 32 combine to form a cable inlet. After entering from the cable inlet, the cable 2 is clamped by the cable clamping channel and passes through the second through hole 331 of the arc-shaped slide plate 33 to be connected to the circuit board 1. A portion of the cable can still remain in the first hemispherical shell 31 and the second hemispherical shell 32, so that it is prevented that the cable 2 is disconnected from the circuit board 1 due to rotation when the cable 2 rotates and moves on the rotation support blocks 611. Since the arc-shaped slide plate 33 is slidable in the arc-shaped grooves 34, the cable 2 is prevented from interfering in a rotational movement direction, thereby improving the stability of rotation.

In some embodiments, the number of rotation support blocks 611 is set to four, and they are evenly arranged in a circular array, thereby enabling the rotating body 3 to rotate and move more stably.

In some embodiments, walls of the arc-shaped grooves 34 are provided with slide grooves, and both sides of the arc-shaped slide plate 33 are provided with slide protrusions 332 corresponding to the slide grooves. The slide protrusions 332 are engaged with the slide grooves, thereby allowing the arc-shaped slide plate 33 to slide more smoothly in the arc-shaped groove 34.

In some embodiments, a pressing plate 7 and a first mounting column 71 are provided in the lower shell 6. The pressing plate 7 is mounted in the lower shell 6 via the first mounting column 71. The pressing plate 7 is provided with a hollowed-out portion 72 corresponding to the hollowed-out body 61. The hollowed-out portion 72 has a four-leaf clover-shaped structure, and a plurality of limiting stop plates 73 are provided around the hollowed-out portion 72.

It should be noted that the hollowed-out portion 72 of the pressing plate 7 can restrict the vertical movement of the rotating body 3 in the hollowed-out body 61 of the lower shell 6, and the limiting stop plates 73 of the pressing plate 7 can restrict the lateral movement of the rotating body 3 in the hollowed-out body 61 of the lower shell 6, thereby improving the rotational accuracy of the rotating body 3.

In some embodiments, the pressing plate 7 is provided with a first boss 74 corresponding to the first mounting column 71. The bottom of the first boss 74 is provided with a positioning groove 741 adapted to the first mounting column 71. The first mounting column 71 is provided with a first screw hole 711, and the first boss 74 is provided with a second screw hole 742 corresponding to the first screw hole 711, thereby improving the mounting accuracy of the pressing plate 7.

In some embodiments, the receiving slots 4 are located at the bottom of the lower shell 6 four directions, with every two of the receiving slots 4 being perpendicular to each other, so that the cable 2 can be moved into the four receiving slots 4.

In some embodiments, the bottom of the lower shell 6 is provided with a disassembly groove 62, thereby facilitating disassembly of the entire backpack power adapter.

In some embodiments, a plurality of second mounting columns 63 are provided in the lower shell 6. The circuit board 1 is mounted in the lower shell 6 via the second mounting columns 63, where at least two of the second mounting columns 63 are provided with second bosses 631.

It should be noted that the second bosses 631 allow the circuit board 1 to be pre-positioned, and then the second self-tapping screws 75 are screwed into the second mounting columns 63, thereby improving the mounting accuracy of the circuit board 1.

In some embodiments, the device body is provided with a spring 8 and a buckle 9 configured to be mounted and positioned with the power tool. One end of the buckle 9 is connected to a movement block 91, and the lower shell 6 is provided with a movement groove 64 corresponding to the movement block. The other end of the buckle 9 is provided with a protruding block 92, and the lower shell 6 is provided with a positioning column 65. One end of the spring 8 is connected to the protruding block 92, and the other end of the spring 8 is connected to the positioning column 65.

It should be noted that when the buckle 9 is pressed, the buckle 9 moves downward along the movement groove 64, so as to be separated from the power tool. When the buckle 9 is released, the rebound force of the spring 8 causes the buckle 9 to return to its original position.

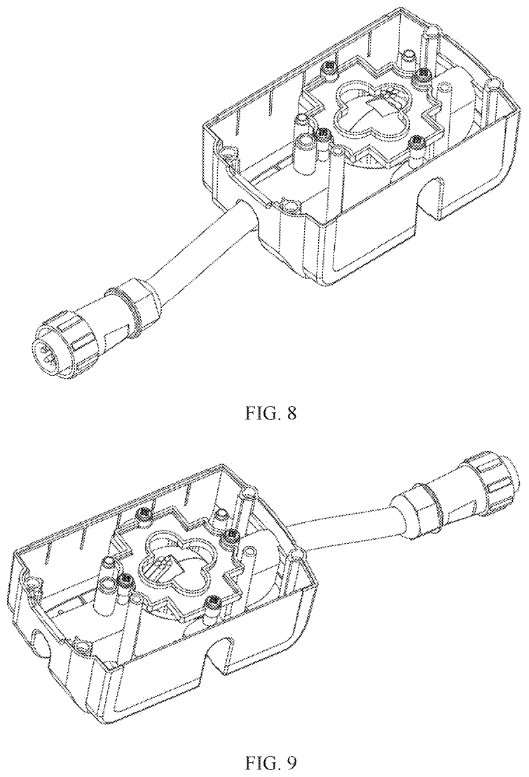

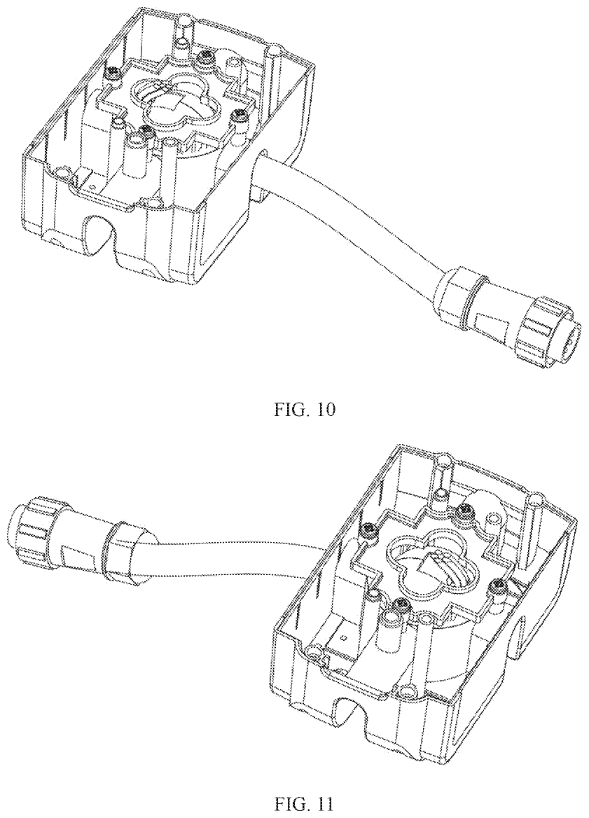

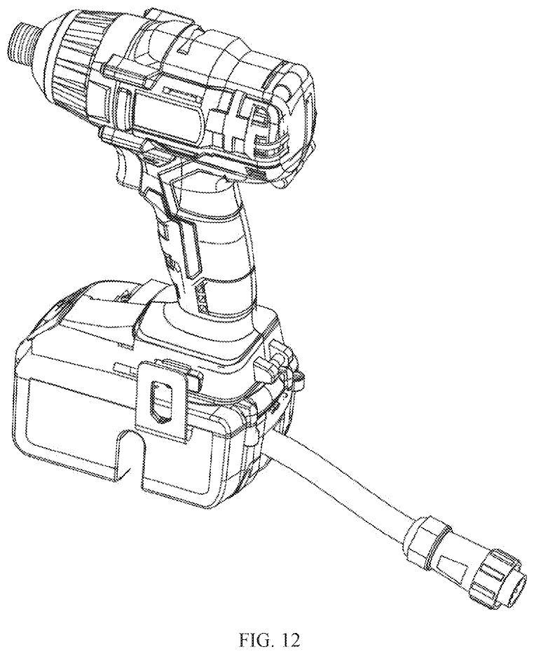

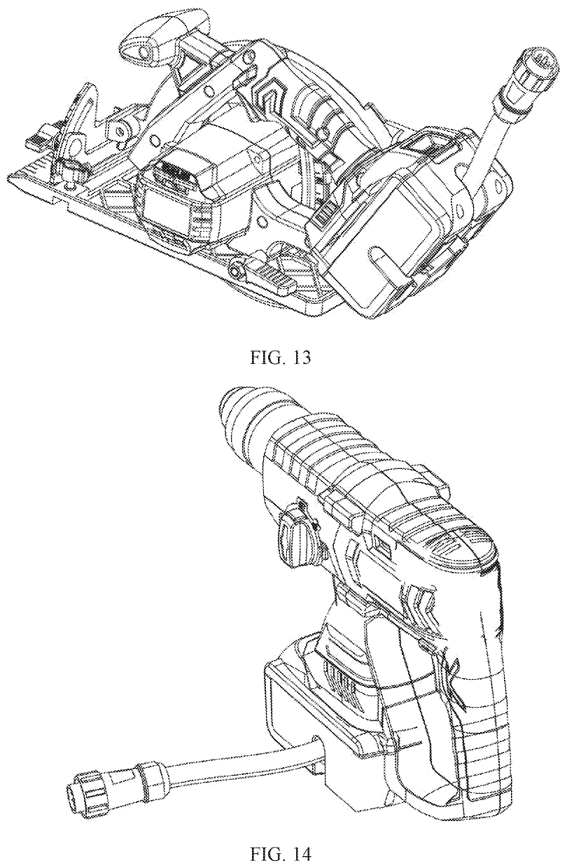

In specific implementation, as shown in FIGS. 8-11, according to specific requirements, the cable 2 is rotated and moved by the rotating body 3 into the front, rear, left, and right cable clamping grooves 35. As shown in FIGS. 12-14, the backpack power adapter can be installed to an electric wrench, a cutting machine, or an electric hammer as needed, thereby expanding the application range and improving the user convenience.

In conclusion, the embodiments of the present invention provide a backpack power adapter, which is provided with receiving slots in multiple directions for receiving the cable. The rotating body allows the cable to be selectively rotated into a receiving slot in any of the multiple directions, thereby greatly expanding the application range and improving the user convenience.

The above only describes specific embodiments of the present application, and the scope of protection of the present application is not limited thereto. Those skilled in the art can make changes or substitutions within the technical scope disclosed in the present application, and such changes or substitutions shall all fall within the scope of protection of the present application.

Those skilled in the art should be understood that, although some embodiments described herein include certain features included in other embodiments but no other features, combinations of features from different embodiments are intended to be within the scope of the present invention and form different embodiments.

Although the embodiments of the present invention have been described with reference to the drawings, those skilled in the art can make various modifications and variations without departing from the spirit and scope of the present invention, and such modifications and variations shall all fall within the scope defined by the appended claims.

What is claimed is:

1. A backpack power adapter, comprising a device body, wherein the device body is provided with a circuit board and a cable configured to supply power to a power tool; a movable rotating body is provided in the device body, and the movable rotating body is provided with a cable passage; a first end of the cable passes through the cable passage and is electrically connected to the circuit board, and a second end of the cable extends out of the device body; and the device body is provided with receiving slots in multiple directions for receiving and clamping the cable.

2. The backpack power adapter according to claim 1, wherein the movable rotating body comprises a first hemispherical shell, a second hemispherical shell, and an arc-shaped slide plate, wherein the first hemispherical shell is connected to the second hemispherical shell; both the first hemispherical shell and the second hemispherical shell are provided with arc-shaped grooves corresponding to the arc-shaped slide plate, and the arc-shaped slide plate is slidably connected in the arc-shaped grooves; both the first hemispherical shell and the second hemispherical shell are provided with cable clamping grooves and first through holes communicating with the cable clamping grooves, and the arc-shaped slide plate is provided with a second through hole.

3. The backpack power adapter according to claim 2, wherein walls of the arc-shaped grooves are provided with slide grooves, both sides of the arc-shaped slide plate are provided with slide protrusions corresponding to the slide grooves, and the slide protrusions are engaged with the slide grooves.

4. The backpack power adapter according to claim 2, wherein the device body comprises an upper shell and a lower shell, and the upper shell is connected to the lower shell; and the lower shell is provided with a hollowed-out body, wherein a plurality of rotation support blocks are provided in the hollowed-out body, and rotation support surfaces of the plurality of rotation support blocks are adapted to the first hemispherical shell and the second hemispherical shell.

5. The backpack power adapter according to claim 4, wherein a pressing plate and a first mounting column are provided in the lower shell, and the pressing plate is mounted in the lower shell via the first mounting column; and the pressing plate is provided with a hollowed-out portion corresponding to the hollowed-out body, the hollowed-out portion has a four-leaf clover-shaped structure, and a plurality of limiting stop plates are provided around the hollowed-out portion.

6. The backpack power adapter according to claim 5, wherein the pressing plate is provided with a first boss corresponding to the first mounting column, and a bottom of the first boss is provided with a positioning groove adapted to the first mounting column; and the first mounting column is provided with a first screw hole, and the first boss is provided with a second screw hole corresponding to the first screw hole.

7. The backpack power adapter according to claim 4, wherein the receiving slots are located ata bottom of the lower shell in four directions, with every two of the receiving slots being perpendicular to each other.

8. The backpack power adapter according to claim 4, wherein a bottom of the lower shell is provided with a disassembly groove.

9. The backpack power adapter according to claim 4, wherein a plurality of second mounting columns are provided in the lower shell, and the circuit board is mounted in the lower shell via the plurality of second mounting columns, wherein at least two of the plurality of second mounting columns are provided with second bosses.

10. The backpack power adapter according to claim 4, wherein the device body is provided with a spring and a buckle configured to be mounted and positioned with the power tool, a first end of the buckle is connected to a movement block, and the lower shell is provided with a movement groove corresponding to the movement block; a second end of the buckle is provided with a protruding block, the lower shell is provided with a positioning column, a first end of the spring is connected to the protruding block, and a second end of the spring is connected to the positioning column.
